(19) United States
(12) Patent Application Publication
(10) Pub. No.: US 2017/0237316 A1
(43) Pub. Date: Aug. 17, 2017

(54) Rotor Shaft Arrangement and Method for Manufacturing the Same

(71) Applicant: Hirschvogel Umformtechnik GmbH, Denklingen (DE)

(72) Inventor: Robert Filgertshofer, Reichling (DE)

(21) Appl. No.: 15/435,655

(22) Filed: Feb. 17, 2017

(30) Foreign Application Priority Data
Feb. 17, 2016 (DE) 10 2016 202 416.7

(51) Int. Cl. H02K 9/00; H02K 9/22; H02K 7/08; F16C 3/02

(52) U.S. Cl. CPC H02K 9/005; F16C 3/02; H02K 9/22; H02K 7/083; F16C 2380/26

(57) ABSTRACT

The present invention relates to a rotor shaft arrangement (1) for a rotor (R) of an electric motor, having a hollow shaft (2) for accommodating a rotor body (K), and a cooling body (3) which is arranged in the hollow shaft (2) and is in thermal contact radially with the hollow shaft (2) and has an axially continuously open structure (S), and therefore a cooling medium in the hollow shaft (2) can flow axially through the cooling body (3). Furthermore, the present invention relates to a rotor (R) with the rotor shaft arrangement (1) according to the invention and also to an electric motor with corresponding rotor (R). The invention also relates to a method for producing the rotor shaft arrangement (1).

The present invention relates to a rotor shaft arrangement for a rotor of an electric motor, to a rotor with said rotor shaft arrangement, to an electric motor with said rotor, and also to a method for producing the rotor shaft arrangement. In particular, the present invention relates to the cooling of corresponding devices.

Different ways of cooling electric motors are known from the prior art. One possibility provides passive cooling in which the heat arising in the electric motor is conducted onto the machine structure via the fastening device. The heat can be transmitted here, for example, via the mounting of the rotor shaft. This leads to a thermally high loading of the bearings which consequently have to be designed with appropriate dimensions. Another possibility provides active air cooling in which air is blown over the motor and therefore the heat is continuously removed from the rotor. A furtheŕ possibility resides in liquid cooling in which liquid coolant circulates in a closed cooling circuit in the corresponding electric motor components. This firstly requires a complex cooling circuit structure. Secondly, such liquid cooling provides an increase in the moving mass, in particular in moving parts of the electric motor, which leads in particular in respect of a possible unbalance and the associated vibrations to a complex configuration of the conduction of the liquid and therefore of the electric motor components as a whole.

It is now an object of the present invention to provide corresponding rotor cooling in a simple manner and with efficient heat dissipation.

This object is achieved by the subject matter of the independent claims The dependent claims develop the central concept of the invention in a particularly advantageous manner.

According to a first aspect, the invention relates to a rotor shaft arrangement for a rotor of an electric motor. Said rotor has a hollow shaft (also called rotor shaft below) for (outer or circumferential) accommodating of a rotor body, such as, for example, a laminated rotor core. Furthermore, the rotor shaft arrangement has a cooling body arranged in the hollow shaft. Said cooling body is in thermal contact radially with the hollow shaft and has an axially continuously open structure such that a cooling medium in the hollow shaft can flow axially through the cooling body; in other words, it can enter the cooling body at one axial end and can leave the cooling body again at the opposite axial end.

The cooling medium here can be any fluid, such as, for example, air or a liquid cooling medium. The axially continuously open structure of the cooling body makes it possible to obtain as large a surface as possible for heat removal via a cooling medium flowing through the cooling body. Furthermore, by means of the separate provision of the hollow shaft, on the one hand, and of the cooling body, on the other hand, said two components can each be designed optimally by themselves and in combination. This firstly applies to the material to be used for the respective components and which can be selected in accordance with the respective task. The hollow shaft can preferably be produced here from a suitable steel while the cooling body can be produced from a material with high heat conductivity, such as in particular aluminum or copper. Secondly, this configuration also permits a simple production of the components since the latter can first of all be produced separately and can subsequently be joined together. An overall complex shape of the rotor shaft arrangement can therefore also be provided in a simple manner. In addition, the continuous removal of heat, which is simple to implement, by means of the cooling body arranged within the hollow shaft results in thermal load alleviation of the bearing points of a corresponding rotor shaft arrangement. This leads in turn to a reduced thermal expansion in said regions and of the associated bearings which can consequently be configured to be narrower and/or smaller. The lower thermal loading consequently also means that the bearings can be operated at higher rotational speed. Consequently, the temperature level of the rotor can be reduced overall by said rotor shaft arrangement and therefore the power (efficiency) of an electric motor operated therewith can be increased. Such rotor cooling should preferably be used in particular for asynchronous motors.

The cooling body and the hollow shaft are preferably connected to each other with a force fit such that the cooling body is supported radially on the inner wall of the hollow shaft; for example via a plurality of points, lines or surfaces, preferably uniformly distributed in an encircling manner, over the circumference of the hollow shaft. This radial supporting effect of the use of the cooling body can safely support a force acting on the hollow shaft, and therefore, for example, the wall thickness of the hollow shaft can be of smaller design in comparison to known embodiments, which can in turn lead to a weight reduction.

The open structure referred to above is preferably formed by defined channels, such as passage openings, or a meshwork structure. In particular, the structure is intended to make it possible for a cooling medium in the hollow shaft to be able to flow axially through the cooling body, wherein the region through which the flow passes is intended to be delimited with as large a surface of the cooling body as possible in order to permit as efficient a removal of heat as possible.

Overall, the cooling body is intended to be designed and provided in the hollow shaft in such a manner that its mass center of gravity lies on the longitudinal axis of the hollow shaft, or the rotor shaft arrangement has its mass center of gravity on the rotation axis of the rotor.

The hollow shaft can have, at least in or on its inner wall facing the cooling body, structural elements which are in contact with corresponding radially outer regions of the cooling body, which regions can likewise preferably be structural elements. A form-fitting connection is preferably intended to be provided here between these two components. The structural elements of the hollow shaft can be designed here, for example, as grooves or fins which can be pressed into the hollow shaft preferably during a deformation operation for producing the hollow shaft. A secure and defined fastening of the cooling body in the hollow shaft can thereby be achieved with simultaneously secure thermal contact between the two components. The structural elements can furthermore ensure relative rotary fixing of the two components.

Overall, the cooling body is intended to be connected to the hollow shaft for rotation therewith. For this purpose, all types of connection also in combination with one another are basically conceivable; in particular a force fit and/or form fit.

The cooling body is preferably designed in order to axially convey the cooling medium through its continuously open structure during rotation of the hollow shaft. In particular, this is made possible by the geometry of said cooling body. For example, the throughflow direction of the cooling medium, the cooling medium itself and also the direction of rotation of a rotor having the rotor shaft arrangement should be involved here in order to provide a defined conveying direction.

According to a preferred embodiment, the cooling body can have at least one and preferably also more, for example at least three, radially extending cooling fins Cooling fins generally have as flat a geometry as possible and therefore provide as large a surface as possible for removing heat with simultaneously small component dimensions and low use of material.

The cooling fins can have, at their radial end facing the hollow shaft, a widened contact region for thermal contact with the hollow shaft. For example, the cooling fins can be of widened design in the region of the inner wall of the hollow shaft, as seen in the circumferential direction, in order, with said widened region, to be in flat contact with the inner wall of the hollow shaft. At least some of the widened contact regions, i.e. a certain number of the widened contact regions, can be formed integrally with one another in order to form as large and flat a contact as possible in particular in the region of the thermal contact of the two components (hollow shaft and cooling body). In a preferred embodiment, the widened contact regions can also all be connected to one another in order therefore to form a peripherally closed ring at the radially outer end of the cooling body, said ring preferably being in flat contact with the hollow shaft. A particularly large surface is therefore provided for removing heat while, because of the open or hollow structure of the cooling body, the weight thereof can be kept as low as possible. The widened contact regions or the closed ring referred to above preferably follow the contour of the hollow shaft or the inner wall thereof in order to provide as extensive a contact region as possible.

The cooling fins can extend axially in the hollow shaft. The cooling fins can extend here, for example, rectilinearly along the longitudinal axis of the hollow shaft. If the cooling body has such cooling fins distributed as uniformly as possible, as seen over its circumference, the cooling body in cross section forms a type of star shape. It is also conceivable for the cooling fins to extend helically around the longitudinal axis of the hollow shaft, and therefore the cooling body is preferably in the shape of a helix. Such a shape is preferred in order to bring about in particular automatic conveying of a cooling medium through the hollow shaft during rotation of the rotor shaft arrangement. Depending on whether the cooling body is designed as a shaped element with an outer cooling structure (for example cooling fins) or as a hollow structure, for example with passage openings, for example in helical form, or else a combination of both, the cooling medium flows outside and/or within the cooling body, and therefore the removal of heat can be set as desired depending on the configuration of the cooling body.

In addition, the configuration with aforementioned and radially extending cooling fins is a preferred variant for the radial support and therefore load alleviation of the hollow shaft. Of course, other embodiments are also conceivable.

The cooling body preferably has, as already mentioned, at least one cooling fin; for example in a configuration thereof in the shape of a helix. In a variant with cooling fins extending longitudinally or axially, the cooling body preferably has at least two and furthermore preferably at least three cooling fins. The cooling fins are then preferably arranged distributed uniformly over the circumference of the cooling body in order to provide a likewise uniform radial support on the inner wall of the hollow shaft. The maximum number of cooling fins is not restricted by the invention and complies in particular with the dimensions of the rotor shaft arrangement and limits caused by the production and materials. For example, up to 50 cooling fins can be provided.

The cooling body can furthermore have an axially extending heat-conducting element from which the cooling fins preferably extend radially outwards. In a preferred embodiment, the heat-conducting element extends here along the longitudinal axis of the hollow shaft and is, for example, of rod-shaped design.

The heat-conducting element can extend axially out of the hollow shaft on one or both sides. In particular, the heat-conducting element can extend out of the hollow shaft on the side facing away from the output side of the rotor shaft arrangement. The heat removed via the cooling body can therefore be reliably removed from the rotor shaft arrangement and consequently from a rotor having said heat-conducting element. For this purpose, the heat-conducting element can furthermore have a heat-removing element at its end extending out of the hollow shaft. This can be, for example, a structural element. The heat-removing element is formed here in particular with an enlarged surface. For example, the heat-removing element can be a disk or else a propeller. That end of the heat-conducting element which extends out of the hollow shaft—and preferably its heat-removing element—can thus be provided in a cooling medium (for example air or a cooling liquid) in order to efficiently remove the heat there outside the rotor shaft arrangement of the rotor having said heat-conducting element.

The heat-conducting element can have an axially extending passage opening which is open axially on both sides for the conduction of a cooling medium. Such a cooling medium could in this case be, for example, a cooling liquid which is conducted through the heat-conducting element in order to further increase the removal of heat from the cooling body. Of course, the conduction of air as a cooling medium is also conceivable. In particular in this case, the passage opening in the heat-conducting element is provided as an additional surface enlargement for removing heat from the entire cooling body through which the flow passes or the entire hollow shaft through which the flow passes.

The hollow shaft preferably has, at its axially opposite ends, bearing seats. The latter are preferably provided on a region of smaller diameter of the hollow shaft in comparison to the region enclosed axially by said bearing seats, for accommodating the cooling body. On account of the radial thermal coupling of the cooling body to the hollow shaft, said cooling body extends substantially over the entire diameter of the hollow shaft, and therefore an axial boundary, securing and optionally thermal coupling can additionally be provided by the region of small diameter for the cooling body. In particular, the cooling body is thereby securely accommodated in the hollow shaft.

The rotor shaft arrangement can be designed here as a monoblock. For this purpose, the cooling body is inserted into the hollow shaft via an axially open end thereof, in particular with an oversize by means of being pressed in, and the open end is subsequently reduced in diameter or is entirely closed by deformation. Alternatively, an engineered variant of the rotor shaft arrangement is also conceivable in which the cooling body is first of all inserted into the hollow shaft in the aforementioned manner (for example pressed in) and then a corresponding additional element is provided at one or both axially opposite open ends of the hollow shaft. This additional element can be inserted (for example pressed), for example, into the axial openings of the hollow shaft. The additional element can preferably have bearing seats which extend axially outward in a preferred embodiment. A combination of the monoblock variant with the engineered variant is basically also conceivable, wherein, for example, after the insertion of the cooling body, the additional elements can be provided at the reduced ends of the hollow shaft.

According to a second aspect, the present invention furthermore relates to a rotor for an electric motor with the rotor shaft arrangement according to the invention and also to a rotor body accommodated on the rotor shaft arrangement or on the hollow shaft thereof. Said rotor body can be, for example, a laminated rotor core.

According to a further aspect, the present invention furthermore relates to an electric motor, such as, for example, an asynchronous engine, with a rotor according to the invention and a stator surrounding the rotor. The heat-conducting element extending axially out of the hollow shaft, if said heat-conducting element is present, can preferably extend with its heat-removing element into a cooling medium, such as air or cooling liquid.

According to a further aspect, the present invention relates to a method for producing a rotor shaft arrangement for a rotor of an electric motor. Such a rotor shaft arrangement preferably corresponds to the rotor shaft arrangement according to the invention. The method according to the invention has the following steps:

providing a hollow shaft for accommodating a rotor body,

providing a cooling body, and

arranging the cooling body in the hollow shaft via an axially open end of the hollow shaft such that the cooling body is in thermal contact radially with the hollow shaft, wherein the cooling body is of axially continuously open design, i.e. has an axially continuously open structure, in such a manner that a cooling medium in the hollow shaft can flow axially through the cooling body.

With the method according to the invention, a rotor shaft arrangement with efficient heat dissipation of the operationally induced heat of the component having the rotor shaft arrangement (for example electric motor) can be provided in a simple manner and which also satisfies the exacting requirements imposed on high speed motors.

For the arrangement of the cooling body in the hollow shaft, the cooling body is introduced preferably axially into the hollow shaft and in particular is pressed into the latter. In particular, the corresponding structural elements of the cooling body, on the one hand, and of the hollow shaft, on the other hand, can be brought here into operative contact with each other in order to correspondingly accommodate and secure the cooling body in the hollow shaft.

After the arrangement of the cooling body in the hollow shaft, the hollow shaft can be deformed at least at its axially open end serving for the introduction of the cooling body. In particular, this deformation can be a reduction; i.e. the diameter of the hollow shaft can be reduced in this region in order to obtain a region of reduced diameter which can have, for example, a bearing seat.

It is also conceivable, after the arrangement of the cooling body in the hollow shaft, to provide an aforementioned additional element at one or both axially open ends of the hollow shaft, which additional element can likewise have a bearing seat. Such an additional element can be inserted here into a non-deformed or deformed (for example reduced) end region of a hollow shaft. An engineered variant of a rotor shaft arrangement according to the invention can thereby be provided which in particular permits a simple installation process in which the introduction of the cooling body can be additionally integrated in a simple manner.

The hollow shaft and/or the cooling body can be produced by a deformation process, such as, for example, forging, or a primary forming process, such as, for example, casting, or else a machining manufacturing method, such as, for example, milling or drilling. A combination of the aforementioned manufacturing methods is also conceivable here. For example, the cooling body can be produced as a cast or forged (aluminum) component, as a component produced by machining the hollow structure and/or as a generatively manufactured component with a hollow structure.

Further embodiments and advantages of the present invention are described with reference to the following exemplary embodiments on the basis of the figures of the accompanying drawings, in which:

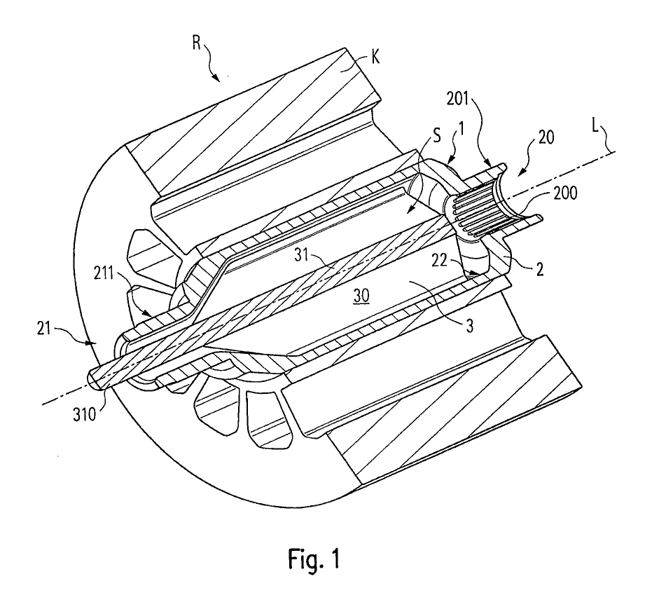

FIG. 1 shows a perspective sectional view of a rotor with a rotor shaft arrangement according to a first exemplary embodiment of the present invention,

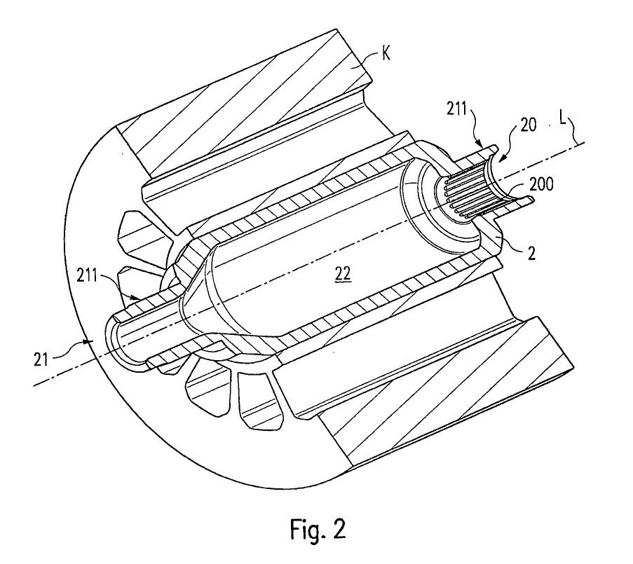

FIG. 2 shows the rotor according to FIG. 1 without a cooling body,

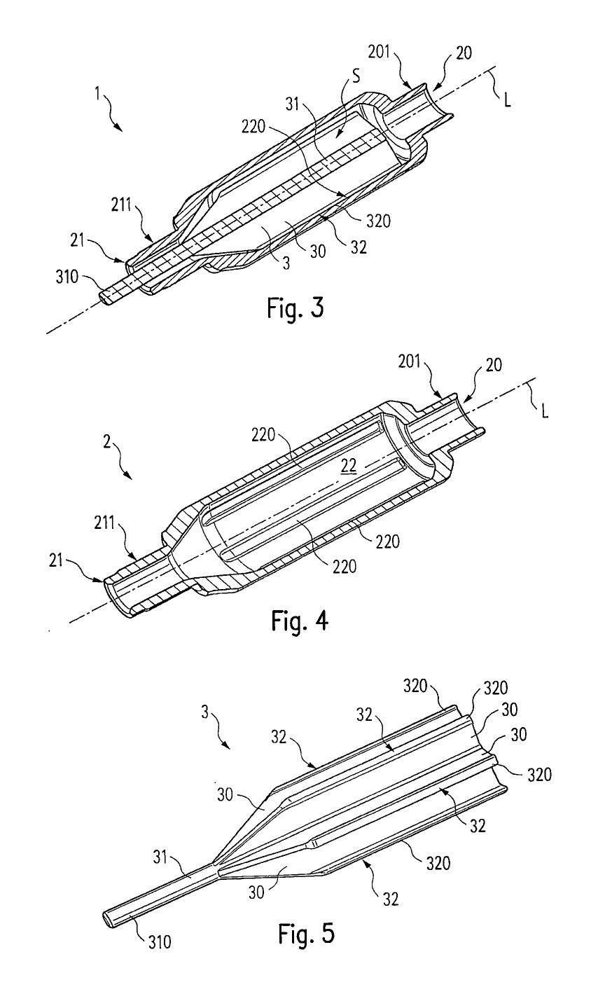

FIG. 3 shows a perspective sectional view of a rotor shaft arrangement according to a second exemplary embodiment of the present invention,

FIG. 4 shows the hollow shaft from FIG. 3, and

FIG. 5 shows the cooling body from FIG. 3 in a non-sectioned illustration.

The figures show different exemplary embodiments of a rotor shaft arrangement 1 according to the invention according to the present invention. Identical reference signs denote identical features here.

The rotor shaft arrangement 1 is, for example, such for a rotor R, as is illustrated in FIG. 1 and can be used, for example, for an electric motor.

The rotor shaft arrangement 1 firstly has a hollow shaft 2 for the (outer) accommodating of a rotor body K. The rotor body K is preferably placed here onto the hollow shaft 2 in such a manner that they are connected to each other for rotation with each other.

The hollow shaft 2 is preferably produced from steel, with other materials also being conceivable, however. The hollow shaft 2 can be produced, for example, by a primary forming process, such as, for example, casting, or else a corresponding deformation process, such as, for example forging. Other manufacturing methods are also conceivable.

At an axial end 20, the hollow shaft 2 preferably has a receiving region 200 for the connection of an output shaft. Said receiving region 200 is designed in FIG. 1 in the form of splines. In the exemplary embodiment illustrated, the hollow shaft 2 also has, at its output end 20, a bearing seat 201 which is provided here by way of example in a region of smaller diameter of the hollow shaft 2.

In a comparable manner, the hollow shaft 2 can also have at its other, here opposite, axial end 21, a bearing seat 211, preferably in a region of smaller diameter.

Furthermore, the rotor shaft arrangement 1 has a cooling body 3 arranged in the hollow shaft 2. As can be seen in FIGS. 1 and 3, said cooling body 3 is in thermal contact radially with the hollow shaft 2. Said thermal contact is achieved in particular by direct physical contact between hollow shaft 2 and cooling body 3. The cooling body 3 is preferably connected here to the hollow shaft 2 with a force fit by the cooling body 3 preferably being pressed into the hollow shaft 2. The cooling body 3 can thereby be supported radially on the inner wall 22 of the hollow shaft 2. A radial force acting on the hollow shaft 2—for example from the rotor body K—can thereby be transmitted to the cooling body 3, and therefore the hollow shaft 2 can be formed overall with a smaller wall thickness, which leads in turn to a reduction in the weight of the rotor shaft arrangement 1.

In particular, the cooling body 3 is intended to be connected to the hollow shaft 2 for rotation therewith, i.e. to be arranged in the latter.

In order to permit as efficient a removal of heat as possible via the cooling body 3, the cooling body 3 is preferably produced from a material having high heat conductivity. In particular, the cooling body can be produced from aluminum or copper. The cooling body can likewise be produced here by a deformation process and/or primary forming process and/or a machining manufacturing method or else a combination of these or other manufacturing methods (for example generative manufacturing methods). For example, the cooling body 3 can be provided as an aluminum cast part or forged aluminum component.

In order to permit high removal of heat, the cooling body 3 has an axially continuously open structure S, and therefore a cooling medium in the hollow shaft 2 and preferably flowing through the hollow shaft 2 can flow axially through the cooling body 3. In other words, the cooling body 3 is of continuously open design in order to provide as large a surface as possible for the removal of heat which is conveyed by a cooling medium flowing completely through the cooling body 3. The open structure S of the cooling body 3 makes it possible to achieve a continuous throughflow of a cooling medium, which has the result of efficient cooling of the components. Even though basically any cooling medium, even liquid cooling media, is conceivable, air is preferably used as the cooling medium. Consequently, the mass moving during operation can also be reduced while an easily available cooling medium can be provided in a simple manner at the same time.

The cooling medium can be conducted through the hollow shaft 2, for example via the end regions 20, 21, which are open axially on both sides, of said hollow shaft. Introduction and/or removal via other regions of the hollow shaft 2 is basically also conceivable. For example, corresponding (radial) channels could thus be introduced into the wall of the hollow shaft 2 in order to allow a certain cooling medium to flow through said hollow shaft and through the cooling body 3.

The open structure S can be provided by defined channels, such as passage openings, or else a meshwork structure, or a combination of both. In particular, for the efficient removal of heat, it is advantageous if the structure S provides as large a surface as possible past which the cooling medium can flow while the latter flows through the hollow shaft 2 and in particular through the cooling body 3.

As can be gathered in in particular FIG. 4, the hollow shaft 2 can have structural elements 220 at least in or on its inner wall 22 facing the cooling body 3. As illustrated in FIG. 4, said structural elements 220 can be designed as grooves or else as fins or a combination of the two. Said structural elements 220 are in turn in contact with corresponding radially outer regions 32 of the cooling body 3, as is apparent in FIG. 3 in the lower region of the rotor shaft arrangement 1 which is illustrated. As shown, for example, in FIG. 5, said radially outer regions 32 are likewise designed here as structural elements 320. The corresponding structural elements 220, 320 are preferably designed here in such a manner that they are connected to one another with a form fit when the cooling body 3 is accommodated in, and preferably pressed into, the hollow shaft 2. By this means, a rotationally fixed connection between hollow shaft 2 and cooling body 3 can also be improved.

As can be gathered from FIGS. 1, 3 and 5, the cooling body 3 can have radially extending cooling fins 30. Cooling fins 30, because of their generally flat configuration, have a large surface which can be used for efficient removal of heat.

As shown in particular in FIG. 5, the cooling fins 30 can have, at their radial end 32 facing the hollow shaft 2, a widened contact region 320 for thermal contact with the hollow shaft 2. Said contact regions 320 are preferably designed in the form of the aforementioned structural element 320 in order to be able to be connected to correspond corresponding structural elements 220 of the hollow shaft 2 preferably with a form fit. Overall, a widened configuration of the cooling fin ends by means of the widened contact regions 320 results in particularly efficient transport of heat from the hollow shaft 2 to the cooling body 3 where the heat can in turn be efficiently removed because of the open structure S.

As not illustrated in the figures, the widened contact regions 320 can also be at least partially formed integrally with one another. As large a contact surface as possible between cooling body 3, on the one hand, and hollow shaft 2, on the other hand, can thereby be provided when they are preferably in full contact with each other. Particularly preferably, the widened contact regions 320, if they are all connected to one another, can be designed as a peripherally closed (contact) ring in order to form a maximum flat contact of the cooling body 3 with the hollow shaft 2. The inner side of such a ring structure also forms a further surface toward the open structure S, which in turn efficiently conveys the removal of heat.

As illustrated in the exemplary embodiments, the cooling fins 30 can extend axially in the hollow shaft 2. Such an axial extent, as illustrated in FIGS. 1, 3 and 5, can be an extent rectilinearly along the longitudinal axis L of the hollow shaft 2. Then, as shown in FIG. 5, the cooling body 3 is in the shape of a star in cross section. The latter is distinguished in particular by a large surface with little use of material and therefore with a low weight.

However, it is also conceivable for the axial extent of the cooling fins 30 to be formed by a helical extent of the cooling fins 30 around the longitudinal axis L of the hollow shaft 2. A cooling body 3 formed in such manner is then preferably in the shape of a helix which can optionally be surrounded by a peripheral contact ring, as previously described. Such a helix shape has in particular the advantage that, during a rotational movement of the rotor shaft arrangement about the longitudinal axis L or about a rotation axis of the rotor R during operation, said helix shape can be used for the active conveying of the cooling medium, which is required for removing heat, through the hollow shaft 2 and consequently through the cooling body 3.

In principle, of course, all other embodiments and directions of extent of cooling fins 30 are also conceivable. For example, it is also possible to provide a plurality of axially spaced-apart groups of cooling fins which are each designed by themselves in the manner of propellers and consequently permit a further improvement in the conveying of a cooling medium through the hollow shaft 2 and the cooling body 3.

The cooling body 3 shown in FIG. 5 has a total of six cooling fins 30, with the invention not being limited thereto. For example, it is also possible for only one cooling fin 30 (for example in a configuration in the shape of a helix) or else for a plurality of cooling fins 30, for example up to 50 cooling fins 30, to be provided. If the cooling fins 30 extend, for example, longitudinally or axially, as illustrated in FIG. 5, the cooling body 3 preferably has at least two and furthermore preferably at least three cooling fins 30. The plurality of cooling fins 30 are then preferably arranged distributed uniformly over the circumference of the cooling body 3 in order to provide a uniform radial support on the inner wall 22 of the hollow shaft 2.

The cooling body 3 can have an axially extending heat-conducting element 31. The cooling fins 30 can extend radially outwards from said heat-conducting element 31, as illustrated in the figures. The heat-conducting element 31 can preferably extend along the longitudinal axis L of the hollow shaft 2. The heat-conducting element 31 consequently forms a receiving region for cooling elements which are preferably arranged rotationally symmetrically and extend therefrom, such as, for example, the cooling fins 30 illustrated here.

In a preferred embodiment, the heat-conducting element 31 extends out of the hollow shaft 2 axially on one side (compare FIGS. 1 and 3) or else on both sides (not illustrated). The heat removed via the cooling body 3 can thereby be reliably removed from the rotor shaft arrangement 1. The heat-conducting element 31 can furthermore have a heat-removing element (not illustrated here) at its end 310 extending out of the hollow shaft 2. Said heat-removing element can be designed, for example, as a shaped element. In particular, the heat-removing element is distinguished by an enlarged surface in comparison to the cross section of the heat-conducting element 31. The heat-removing element can be designed, for example, as a disk and particularly preferably as a propeller in order to permit as efficient a removal of heat as possible. The heat-removing element can be provided here within a region with cooling medium. The cooling medium can be a liquid; or preferably also air.

As not illustrated in the embodiments of the figures, the heat-conducting element 31 can have an axially extending passage opening which is open axially on both sides for the conduction of a cooling medium. The passage opening likewise extends here preferably along the longitudinal axis L of the hollow shaft 2. Said passage opening can serve, for example, for the conduction of a liquid cooling medium. It is also conceivable for said passage opening to serve for the additional enlargement of the surface of the cooling body 3 and therefore for increased removal of heat.

It has already been mentioned that the hollow shaft 2 preferably has bearing seats 201, 211 at its axially opposite ends 20, 21. Said bearing seats are preferably provided on a region of smaller diameter of the hollow shaft 2; this in particular in comparison to the region enclosed axially by said bearing seats, for accommodating the cooling body 3 in the hollow shaft 2.

As illustrated in FIG. 1, the rotor shaft arrangement 1 together with a rotor body K accommodated thereon or on the hollow shaft 2 thereof forms a rotor R according to the invention. Said rotor R in turn together with a stator (not shown) surrounding said rotor forms an electric motor according to the invention. The latter can then customarily be correspondingly arranged and designed in order to be correspondingly operated and to remove the generated torque. The torque can be undertaken here, for example, via an output shaft arranged on the output side 200.

The heat-conducting element 31, which extends axially out of the hollow shaft 2, of a corresponding electric motor can extend, preferably with its heat-removing element, into a cooling medium, such as, for example, air or cooling liquid, in order to provide as efficient a removal of heat for the electric motor as possible. Since in particular very high removal of heat can already be achieved with air as the cooling medium, the present invention provides for removal of heat with maximum efficiency with a simultaneously small moving mass and in particular with a particularly simple structural configuration and installation.

A method for producing a rotor shaft arrangement 1 for a rotor R of an electric motor is illustrated below.

In a first step, a hollow shaft 2 is provided for accommodating a rotor body K. Such a rotor body K can be, for example, a laminated rotor core. The hollow shaft 2 can be produced in any manner and is provided in particular from steel. The hollow shaft 2 can be produced, for example, by means of a deformation or primary forming process or else a machining manufacturing method and also by means of a generative manufacturing method. Any combination of these or other manufacturing methods is also conceivable.

In a second step, a cooling body 3 as also shown by way of example in FIG. 5 is provided. Said cooling body 3 is preferably produced from a highly heat-conducting material, such as, for example, aluminum. Examples of suitable manufacturing methods here are, for example, deformation methods, primary forming methods or else machining or generative manufacturing methods or any combination thereof.

In a further step, the cooling body 3 is arranged in the hollow shaft 2 via an axially open end 21 of the hollow shaft 2 such that the cooling body 3 is in thermal contact radially with the hollow shaft 2. In particular, for this purpose, the cooling body 3 can be introduced axially into the hollow shaft 2 and can preferably be pressed into the hollow shaft 2. The cooling body 3 can thereby also provide a radial supporting effect for the hollow shaft 2 which consequently can be provided, for example, with a smaller wall thickness. The cooling body 3 here has an axially continuously open structure S in such a manner that a cooling medium in the hollow shaft 2 can flow axially through the cooling body 3. The combination of providing a large surface with a component geometry which is overall simple or is simple to produce ensures simple provision of a highly efficient heat-removing cooling construction of the rotor shaft arrangement 1 according to the invention for a rotor R of an electric motor.

As already described above, the cooling body 3 is arranged in the hollow shaft 2 via an axially open end 21 thereof. After the corresponding arrangement of the cooling body 3 in the hollow shaft 2, the hollow shaft 2 can be deformed and in particular reduced at least at its axially open end 21 serving for the introduction of the cooling body 3, in order preferably to form a region of reduced diameter. As illustrated in FIGS. 1 to 4, said region can then serve, for example, as a bearing seat 211. Furthermore, the region of reduced diameter can also serve for axially blocking or fixing the cooling body 3 in the hollow shaft 2.

The rotor shaft arrangement 1 can (additionally) also be provided as an engineered variant. In this case, after the arrangement of the cooling body 3 in the hollow shaft 2, an additional element is provided at the one or both axially open ends 20, 21 of the hollow shaft 2. Said additional element is preferably pressed into the hollow shaft 2 in order to at least partially close the open ends. The corresponding additional element can likewise have, for example, the bearing seats 201, 211 here. Furthermore, the additional element can have the structural elements 200 for removing the torque provided by means of the rotor shaft arrangement 1. Also, one or both of the additional elements can have an opening via which the heat-conducting element 31 can extend axially out of the hollow shaft 2 in order to provide removal of heat to the outside.

The present invention is not limited to the previous exemplary embodiments as long as it is covered by the subject matter of the claims that follow. In particular, the cooling body 3 can be formed geometrically in any manner if it is thermally coupled to the hollow shaft 2 and is of continuously open design in order to allow a cooling medium to flow through said cooling body so as, in turn, to permit a correspondingly efficient removal of heat. Furthermore, the previously described rotor shaft arrangement 1 can basically be used for any type of shaft which in particular requires removal of heat arising during operation.

1. Rotor shaft arrangement (1) for a rotor (R) of an electric motor, having:
a hollow shaft (2) for accommodating a rotor body (K), and
a cooling body (3) which is arranged in the hollow shaft (2) and is in thermal contact radially with the hollow shaft (2) and has an axially continuously open structure (S), and therefore a cooling medium in the hollow shaft (2) can flow axially through the cooling body (3).

2. Rotor shaft arrangement (1) according to claim 1, wherein the cooling body (3) and the hollow shaft (2) are connected to each other with a force fit, and, preferably, the cooling body (3) is pressed into the hollow shaft (2) such that the cooling body (3) can be supported radially on the inner wall (22) of the hollow shaft (2).

3. Rotor shaft arrangement (1) according to claim 1, wherein the open structure (S) is formed by defined channels, such as passage openings, or a meshwork structure.

4. Rotor shaft arrangement (1) according to claim 1, wherein the hollow shaft (2) has, at least in/on its inner wall (22) facing the cooling body (3), structural elements (220), in particular grooves or fins, which are in contact with corresponding radially outer regions (32), in particular structural elements (320), of the cooling body (3), and, preferably, are connected to said regions with a form fit.

5. Rotor shaft arrangement (1) according to claim 1, wherein the cooling body (3) is designed in order to convey the cooling medium axially through its continuously open structure (S) during rotation of the hollow shaft (2).

6. Rotor shaft arrangement (1) according to claim 1, wherein the cooling body (3) has radially extending cooling fins (30), wherein the cooling body (3) preferably has at least one cooling fin, furthermore preferably at least three cooling fins (30).

7. Rotor shaft arrangement (1) according to claim 6, wherein the cooling fins (30) have, at their radial end (32) facing the hollow shaft (2), a widened contact region (320) for thermal contact with the hollow shaft (2), wherein at least some of the widened contact regions (32) are formed integrally with one another, preferably as a peripherally closed ring, and are preferably in flat contact with the hollow shaft (2).

8. Rotor shaft arrangement (1) according to claim 6, wherein the cooling fins (30) extend axially in the hollow shaft (2), in particular rectilinearly along the longitudinal axis (L) or helically about the longitudinal axis (L) of the hollow shaft (2), wherein the cooling body (3) is preferably in the shape of a star or helix.

9. Rotor shaft arrangement (1) according to claim 1, wherein the cooling body (3) has an axially extending heat-conducting element (31) from which the cooling fins (30) preferably extend radially outwards, wherein the heat-conducting element (31) preferably extends along the longitudinal axis (L) of the hollow shaft (2).

10. Rotor shaft arrangement (1) according to claim 9, wherein the heat-conducting element (31) extends axially out of the hollow shaft (2) on one or both sides, and wherein the heat-conducting element (31) preferably has, at its end (310) extending out of the hollow shaft (2), a heat-removing element, in particular with an enlarged surface, such as, for example, a propeller or a disk.

11. Rotor shaft arrangement (1) according to claim 9, wherein the heat-conducting element (31) has an axially extending passage opening which is open axially on both sides for the conduction of a cooling medium.

12. Rotor shaft arrangement (1) according to claim 1, wherein the cooling body (3) is produced from a material having high heat conductivity, such as in particular aluminum or copper.

13. Rotor shaft arrangement (1) according to claim 1, wherein the hollow shaft (2) preferably has, at its axially opposite ends (20, 21), bearing seats (201, 211) which are preferably provided on a region of smaller diameter of the hollow shaft (2) in comparison to the region enclosed axially by said bearing seats, for accommodating the cooling body (3).

14-21. (canceled)
